(19) United States
(12) Patent Application Publication
(10) Pub. No.: US 2007/0184157 A1
(43) Pub. Date: Aug. 9, 2007

(54) Hot fill and quick chill process for premium quality juice

(75) Inventor: Brett Stegmaier, Auburndale, FL (US)

Correspondence Address: LOTT & FRIEDLAND, P.A., P.O. BOX 141098, CORAL GABLES, FL, 33114-1098, US

(73) Assignee: Citrus World, Inc.

(21) Appl. No.: 11/348,653

(22) Filed: Feb. 7, 2006

(51) Int. Cl. A23B 5/005

(52) U.S. Cl. 426/399

(57) ABSTRACT

A process for hot filling and quick chilling a premium juice, while retaining the premium qualities of the juice, by quickly chilling the juice following the hot fill process and by maintaining refrigeration of the juice through out storage and shipment of the juice. The process further includes rapidly chilling the diverted and overflow product which is being returned to the pre-chilled batch tank.

### FIELD OF INVENTION

The invention relates generally to a process for hot filling a premium not-from-concentrate juice, while retaining the premium qualities of the not-from-concentrate juice by quickly chilling the juice following the hot fill process, by rapidly chilling the diverted and overflow product which is being returned to the pre-chilled batch tank and by maintaining refrigeration of the juice throughout storage and shipment of the juice.

### BACKGROUND OF THE INVENTION

Not-from-concentrate juices are premium products, providing superior flavor in comparison to juices which are reconstituted from concentrates. Premium not-from-concentrate juice is typically cold filled in consumer packages or containers as this provides a better flavor juice. Cold filled products typically have -a shorter shelf life when compared to hot filled products. From-concentrate juices are typically hot filled, resulting in sterile, shelf-stable packages with extended shelf life. The shelf life of not-from-concentrate juices traditionally has been shorter than from-concentrate juices due to the inability to effectively sterilize packaging and product during cold filling. Juices that are hot filled are typically a lower grade of juice and are not considered premium juices.

Aseptically processed juice is subjected to high heat, then chilled, placed in sterile containers, and hermetically sealed. Aseptic processing and filling systems have been installed by many manufacturers in recent years to cold fill not-from-concentrate products in shelf stable packages with extended shelf life, but the cost of installing and maintaining aseptic systems is exceptionally high. The present invention uses a hot fill operation to produce high quality, not-from-concentrate products with an extended shelf life, at a significantly lower cost than aseptic systems.

Pasteurization can be performed after a package is cold filled. Once cold filled, the package is subjected to a higher temperature for an extended period of time. However, during the filling process of juice, the use of the highest temperature for the shortest period of time often provides the best result, which increases nutrient and flavor retention. Another available option is flash pasteurization of juices, whereby the juice is quickly heated to just a high enough temperature to kill the bacteria. During flash pasteurization, the juice is heated to approximately 176° F. to 203° F. While E. coli is destroyed from flash pasteurization, the product is not sterile and still requires refrigeration at 39° F. to about 45° F.

The hot fill process includes pasteurization of the juice, which kills a majority of the bacteria present and extends the shelf life of the juice. The hot fill is usually done at 180° F. and causes a fairly significant loss of flavor. The hot fill process is known for other liquids, including beverages and soups. The hot fill process is less popular for juice products due to the increased loss of flavor of the hot filled juice.

U.S. Pat. No. 4,830,865 to McFarlane et al. describes a method and apparatus for continuously and gently aseptically processing a food product comprising delicate food chunks of fruit or vegetables in a liquid. The apparatus includes a heating, holding and cooling enclosure. The method and apparatus described in the '865 patent is intended to retain the flavor and texture of the product by heating the product rapidly to a sterilization temperature, holding the product at the temperature only long enough to sterilize it and cooling it quickly. The cooling apparatus uses a coolant, such as cold water, fed into a cooling enclosure.

U.S. Pat. Nos. 5,555,702 and 5,494,691 to Sizer describe an apparatus and process for packaging liquid food products. The process may be employed for filling gable top cartons with high acid liquids such as orange juice. The product is heated to a sufficiently high temperature to sterilize the product for a short period of time and then cooled to an intermediate temperature that is sufficiently high to avoid the growth of bacteria and at an intermediate temperature, the product is placed in unsealed gable top carton. In the preferred embodiment, the juice is heated to a temperature of 95° C. for 20 seconds then cooled to about 70° C. The juice is then filled into a carton and the temperature is maintained at 70° C. while the carton is inverted. The product is then cooled to room temperature over a period of 40. minutes.

United States Application Publication No. US 2004/0131735 to Korengel et al. describes a post-filling heat dwell for small-sized hot filled juice beverage containers. The method incorporates a warming tunnel closely downstream of a hot filling apparatus which is set up to fill relatively small volume capacity polymeric containers not greater than 12 fluid ounces. The hot filled containers are conveyed through a warming tunnel which provides a heated environment which is higher in temperature than the environment, thereby maintaining the temperature of the beverage within the containers at an adequate temperature for an adequate time so as to complete needed heat treatment of the beverage in each container.

U.S. Pat. No. 4,874,617 to Sole describes a process for obtaining banana juice, banana essence and/or de-flavored banana juice from whole, ripe bananas. This process uses a glycol-cooled swept surface exchanger to cool the juice to a temperature of 32° F. to 40° F. The cooling process also serves to draw essence from the juice through separation by condensation of vapors.

U.S. Pat. No. 1,980,695 to Polk describes a process for preserving fresh fruit juices. The process includes extracting juice from fruit that has been pre-cooled to a temperature approximately the freezing point. The juice, remaining at low temperatures, is subjected to a relatively high vacuum and is agitated. The juice then stands at the steady vacuum, allowing solid material to rise to the surface to be removed. The juice is then placed in containers which are sealed under vacuum. Where the final product is to be in frozen form, the sealed containers are refrigerated in a manner to effect freezing of their contents as quickly as possible under conditions minimizing physical separation of the dissolved and suspended solid constituents from the associated water content. The containers are preferably pre-cooled to approximately the freezing point. The flash-freezing process typically involves a freezing bath of suitable liquid maintained at −50° F.

U.S. Pat. No. 5,085,882 to Rausing describes a method for the cooling of a product flow containing a solid and/or semi-solid foodstuff particles. The flow is separated into a high particle flow, and a low particle flow which is cooled separately from the high particle flow and is used later as a cooling medium for the cooling of the high particle flow. The method can be used in aseptic packaging wherein a heat-treated, cooled foodstuff product is packed in sterilized containers under aseptic packing conditions. The method teaches that the desired sterilization temperature preferably be as rapid as possible, and that the cooling process after the sterilization ought to be carried out rapidly also so that the total heat load on the foodstuff can be kept to a minimum. The method solves the problem of cooling the heated product flow equally quickly as it is heated in order to effect minimization of the total heat load on the product during cooling. The method is directed to solid or semi-solid food products, because they require longer cooling periods.

U.S. Pat. No. 4,409,775 to Brody et al. describes an apparatus for the aseptic packing of high acid foods. The apparatus includes conveying means with carrier plate receptacles having orifices to receive preformed cups, the orifices to receive preformed cups for filling. The disclosure teaches that chilled juice and other high acid packaged products minimize the problems of microbial and oxygen presence by low temperature distribution which reduces the rate of microbial propagation and the rate of biochemical reaction of oxygen and product. After sealing, the containers on the apparatus are conveyed through a continuous microbiological and gas barrier, such as an aqueous liquid sterilant curtain, which aids in setting the seal by decreasing its temperature, and which separates the commercially sterilized and inter interior part of the apparatus from the ambient atmosphere.

U.S. Pat. No. 5,374,435 to Silvestrini et al. describes a method of batch cooking and packing fruit and vegetable pieces. The food product is heated in a cooking chamber by re-circulating a liquid through a heat exchanger to a cooking and sterilizing temperature. The product is then deposited into a shipping container. The food product is optionally cooled prior to being deposited in the shipping container. This method teaches of the use of a coolant, which may suitably be water, glycol or brine, at a predetermined low temperature, preferably not more than about 5° C. The food product is cooled to approximately 35° C. then deposited in the shipping container.

U.S. Pat. No. 5,500,241 to Balasingham et al. describes the process of manufacturing kiwi juice. The process requires that the pulp fraction of the kiwi be cooled to 10° C. within 90 minutes of pulping. The pulp and liquid remain at cool temperatures throughout the process. A stainless steel heat exchanger uses a glycol coolant to rapidly cool the product to 0° C. to −10° C. after blending with a sweetener. The cooled product is packaged in containers and frozen.

U.S. Pat. No. 5,597,604 to Chalupa et al. describes a gellan gum beverage and the process for making the gelled beverage. The process includes heating the beverage and concurrently rapidly cooling and shearing the beverage. The beverage is typically heated to about 140° F. to about 212° F. for 5 to 15 minutes then concurrently rapidly cooled to between about 40° F. to about 59° F. while shearing the beverage. The heating and cooling processes are used to cause the beverage to gel.

U.S. Pat. No. 6,235,337 to Imamura et al. describes a soybean milk pack and process. In one embodiment, the soybean milk is filled in the containers at a temperature of 80-95° C. The container and milk is rapidly cooled and stored at 1-10° C. With this treatment, even if germs are not sterilized by the high temperature during filing, the germs are sterilized at low temperatures, while the milk is stored at low temperatures.

None of the methods and apparatus mentioned above describe a hot fill and quick chill process to fill containers with premium not-from-concentrate juice, while retaining a premium quality juice. None of the references disclose a hot fill and quick chill process for premium quality juice, particularly, immediately and quickly cooling the juice to below 50° F. with a chilled water spray after the hot fill process when the beverage is put in a container and maintaining the cooled temperature through delivery. Neither do any of the references disclose using a rapid cooling system for normally diverted juice and overflow juice to reduce the juice temperature to approximately 33° F. to approximately 50° F., and preferably to approximately 40° F. to approximately 50° F., prior to returning the juice to a pre-chilled batch tank in the hot fill process. In fact, none of the references disclose such improvements to the hot fill process for any beverage.

In a typical hot-fill pasteurized beverage packaging process, raw product is transported from a raw product batch tank to pasteurizing equipment. From the pasteurizing equipment, the pasteurized product is transported to a filling station. In these systems, a small portion of product can be returned to the batch tank for re-processing at two stages of the process. Product can be “diverted” to the batch tank immediately after the pasteurization process if it does not reach the proper temperature. Product can be returned to the batch tank as “overflow” from the filling station if it exceeds the packaging capacity of the filling equipment. The excess overflow product is normally introduced by design in order to improve the efficiency of the filling process and the quality of the packaged product.

A typical pasteurization process uses a flow diversion valve to ensure that the product has reached a sufficient temperature during pasteurization. The divert valve assumes a forward-flow position if the beverage passes the recorder-controller at the preset temperature. The divert valve diverts the flow if the beverage has not achieved preset temperature. Improperly heated beverage flows through the diverted flow line of the divert valve back to the raw beverage batch tank. Properly heated beverage flows through the forward flow part of the divert valve to the pasteurized beverage filling station. When the process is running efficiently, only a small portion of the product is diverted. Typical pasteurization processes also contain an overflow path for juice that has been pasteurized, but does not fill containers. Such overflow juice is recycled back to the batch tank. In continuous pasteurization, the overflow serves to maintain a higher pressure on the pasteurized side of the heat exchanger by removing some of the pasteurized beverage volume. By keeping the pasteurized beverage at least 1 psi higher than raw beverage, it prevents contamination of pasteurized beverage with raw beverage.

During juice pasteurization and filling processes, diverted flows and overflows not reaching consumer packages must be cooled prior to reprocessing. Typical hot fill operations utilize heat exchangers with ambient water as the cooling media to reduce the juice temperature for diverted and overflow beverages to an ambient temperature before it re-enters the batch tank. This is a slow process and does not reduce the temperature of the diverted and overflow beverage to below an ambient temperature. However, to protect the premium qualities of not-from-concentrate juice, the duration the juice is held at high temperatures must be minimized. Accordingly, there is a need in the art for a method which is capable of minimizing the duration that juice is held at high temperatures. There is a further need in the art for a method for a rapid chilling system which utilizes cooling media at approximately 25° F. to approximately 32° F. to quickly reduce juice temperature below 50° F.

Typical hot fill operations utilize ambient water to slowly cool hot filled packages or containers to ambient temperature. However, to preserve the premium qualities of juice, the duration the packaged products are held at high temperatures after filling should be minimized. Additionally, it is desired to rapidly lower the temperature of the juice to below ambient temperature to preserve the premium qualities of the juice. Accordingly, there is a need for a rapid chilling system that supplies cooled water at approximately 33° F. to about 45° F., preferably about 35° F., to quickly reduce hot filled packages or containers to less than 50° F.

Most often hot filled product containers are shipped and stored in ambient conditions. Shipping and storage in ambient conditions can affect the premium qualities of juice products. There is a need for refrigerated transportation and storage of juice products produced by hot filled containers being immediately cooled, thus retaining premium product qualities throughout an extended shelf life.

### SUMMARY OF THE INVENTION

The current invention satisfies the above needs by providing a method of a hot fill and quick chill process for premium quality juice, particularly, immediately cooling the juice to below 50° F. after the hot fill process when the beverage is put in a container and maintaining the cooled temperature through delivery, and using a glycol/water chilling system for beverage returning to the batch tank in the hot fill process.

The invention provides a process for hot filling a beverage into containers comprising the steps of (a) pasteurization of a pre -chilled beverage stored in a batch tank; (b) rapidly cooling diverted beverage and overflow beverage and returning it to a batch tank; (c) filling a container with the hot beverage and sealing the container; (d) rapidly cooling the filled beverage container with a chilled water spray; and (e) maintaining refrigeration of the filled beverage container throughout shipment and storage.

The invention further provides for a process for hot filling not-from-concentrate juice in containers. The process comprises: (a) pasteurization of a chilled not-from-concentrate juice; (b) filling a container with the hot not-from-concentrate juice and sealing the container; (c) rapidly cooling the filled not-from-concentrate juice container with a chilled water spray; and (d) maintaining refrigeration of said filled not-from-concentrate juice containers throughout shipment and storage.

The invention also provides for a process for hot filling not-from-concentrate juice in containers while retaining a premium not-from-concentrate juice flavor. The process begins with chilled not-from concentrate juice in a batch tank. The chilled not-from-concentrate juice is then pasteurized. The not-from-concentrate juice which has been diverted from a process flow after pasteurization is rapidly cooled through use of a heat exchanger prior to returning said not-from-concentrate juice to said batch tank. The not-from-concentrate juice which is overflow from a filling station is rapidly cooled through use of a heat exchanger prior to returning the not-from-concentrate juice to said batch tank. Containers are then filled with the not-from-concentrate juice and sealed. The filled not-from-concentrate juice container is rapidly cooled with a chilled water spray. Refrigeration of the filled not-from-concentrate juice containers is maintained throughout shipment and storage.

These and other objects, features, and advantages of the present invention may be better understood and appreciated from the following detailed description of the embodiments thereof, selected for purposes of illustration and shown in the accompanying drawings.

### BRIEF DESCRIPTION OF THE DRAWINGS

FIG. 1 is process diagram of the hot fill and quick chill process.

### DETAILED DESCRIPTION

Provided is a method of hot filling and quick chilling a premium juice, while retaining the premium qualities of the juice by quickly chilling the juice following the hot fill process, by rapidly chilling the diverted product which is being returned to the batch tank and by maintaining refrigeration of the product through out storage and shipment of the juice.

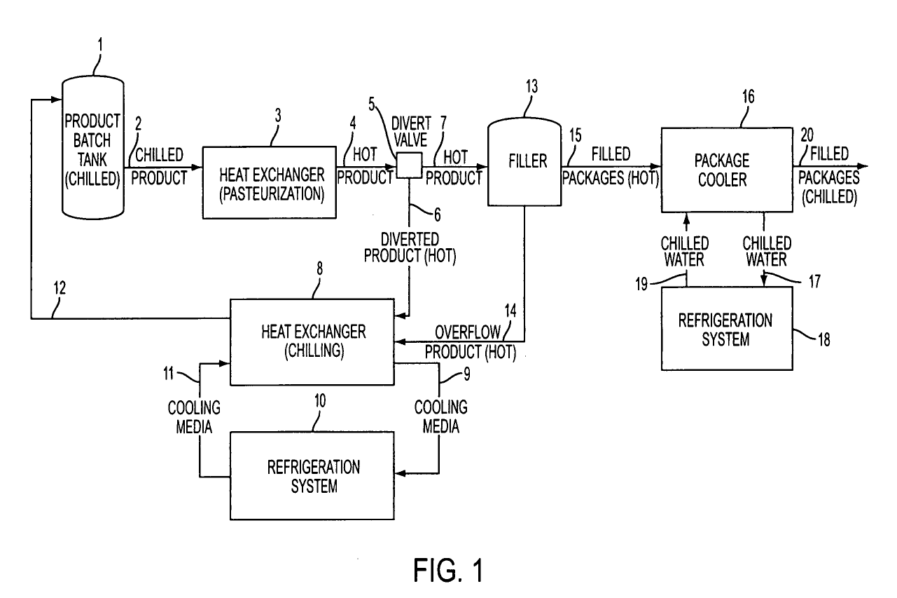

As shown in FIG. 1, the hot fill process of the invention begins with a juice product in a batch tank at a chilled temperature 1. In step 2 the chilled product is moved into a heat exchanger 3 for pasteurization. Many methods of pasteurization are known. In the preferred embodiment, a tube-in-tube system is employed; however, other known methods of pasteurization may be used while retaining the benefits of the disclosed method. The tube-in-tube heat exchanger comprises a heating medium which is not in direct contact with the product, but separated by equipment contact surfaces. The heating medium is found in the outside tube while the product flows through the inner tube. The principle is based on the thermal exchange between the heating medium and the product, carried out in concentric tubes, which allows for a high level of uniformity in treatment. In the heat exchanger 3, the temperature of the beverage is raised to between approximately 195° F. to approximately 215° F. In the preferred embodiment, the temperature of the beverage is raised to 205° F. The duration that the beverage is kept at the optimal pasteurization temperature varies by product and flow rate. The beverage exits the heat exchanger 3 at approximately 185° F. The heat exchanger 3 includes a trim cooler that begins to lower the temperature of the beverage and a deaerator vessel, where excess air is removed from the beverage.

In step 4 the now hot product passes through a divert valve 5. In step 6 the divert valve 5 diverts some of the hot product to be re-circulated back to the batch tank 1. Diverted product is typically composed of product that did not reach the appropriate temperature during the pasteurization process. Diverted hot product enters a heat exchanger 8 for rapid cooling before it is sent back to the batch tank 1. The cooling media 9 and 11 is preferably a chilled glycol/water mixture. The cooling media 9 and 11 is kept at temperatures of approximately 28 to 30° F. by a refrigeration system 10. The cooling media 9 and 11 is circulated through refrigeration system 10 after it passes through the heat exchanger 8. After the product is rapidly cooled to below 50° F., the product exits from the heat exchanger 8 and returns to the batch tank 1 in step 12.

Referring back to the divert valve 5, product which is not diverted passes on to a filler process 13 in step 7. Product which does not fill a container or package is considered overflow product and is sent to the heat exchanger 8 in step 14. This is a normal flow when product did not fill a package and amounts to typically less than 10% of the product when the system is running efficiently. Overflow product can be used to maintain a pressure differential between pasteurized and non-pasteurized product and ensure a proper directional flow to prevent contamination. As shown in step 14 and step 6, overflow product joins diverted product as it enters the heat exchanger 8. As mentioned above, the hot product enters a heat exchanger 8 for rapid cooling before it is sent back to the batch tank 1. The cooling media 9 and 11 is preferably a chilled glycol/water mixture kept at an optimal temperature by refrigeration system 10. After the product is rapidly cooled to below 50° F., the product exits from the heat exchanger 8 and returns to the batch tank 1 in step 12.

The chilling system 8, 9, 10, 11 for the return to the batch tank 1 of the invention better protects the premium juice qualities by rapidly reducing the temperature of the diverted product and overflow product and minimizing the time the juice remains at a high temperature. The chilling system 8, 9, 10, 11 rapidly cools diverted product and overflow product, which is being returned back to the batch tank 1. A typical heat exchanger will utilize ambient temperature water to slowly cool this flow. The invention uses a chilled glycol/water mixture as cooling media 9, 11 to achieve lower final beverage temperatures faster. The chilled glycol/water mixture is approximately 28 to 30° F. in the preferred embodiment. Other known cooling media and temperatures may be employed.

Product that is hot filled in packages or containers 13 moves to a package cooler 16 in step 15. The package cooler 16 is a wide tunnel that is approximately 8 feet across. As the packages pass into the package cooler 16, the movement of the packages slows down as the packages fill the wide opening. A typical cooling process uses a room temperature water bath or spray to slowly reduce the temperature of the hot filled juice and container over a long cooling curve to ambient temperature. The cooling process of the invention involves spraying chilled water 17, 19 over the containers immediately after the containers are hot filled in step 13 and moved into the package cooler 16. The package cooler sprays water chilled by refrigeration system 18. Water is re-circulated to the refrigeration system 18 to maintain the cool temperature of the water. The refrigeration system 18 can use various known refrigerants to cool the water, such as ammonia. Chilled water moves out of the package cooler in step 17 and back into the package cooler in step 19. This recirculation keeps the water sprayed in the package cooler 16 at temperatures of approximately 35° F. When the chilled water is sprayed over the packages or containers it quickly brings down the temperature of the product and container. The beverage is rapidly cooled from approximately 184° F. to below 50° F. The cooling times vary by container size and last approximately 7 to 30 minutes depending upon the container size. The rapid cooling process of the invention serves to retain the premium quality of the beverage by minimizing the time the beverage spends at elevated temperatures. To speed up the cooling process, the containers may be agitated during the cooling process in the package cooler, which increases the heat transfer and reduces the cooling time.

In order to maintain the premium quality of the juice, it is preferred to maintain refrigeration at 35° F. to 40° F. through out the shipment and storage of the beverage and most preferably at about 35° F. After the filled packages are chilled in the package cooler 16 the filled packages move on to storage and shipment in step 20. The filled packages remain chilled through the remainder of the supply chain including storage, shipment and ultimately consumer consumption. The typical hot filled product is shipped and stored under ambient conditions. Keeping the product refrigerated protects the premium juice qualities and achieves an extended shelf life for the product. The hot filling and quick chilling processes of the invention can be used for various package containers, including, but not limited to glass containers, plastic containers, cartons, pouches and cans.

A not-from-concentrate juice produced by the above process exhibits flavor qualities similar to a not-from-concentrate juice that had undergone aseptic cold filling and superior flavor qualities when compared to a from-concentrate juice that was hot filled. A consumer sensory test was undertaken to compare the taste of not-from-concentrate juice produced by the present invention with another cold filled premium juice and a hot filled from-concentrate juice. The juice packaged by the process of the invention was three months old at the time of the test. The product had been in refrigeration at approximately 38° F. since it was packaged. Two other well known brands of juice were tested. One was a not-from-concentrate juice called TROPICANA Pure Premium Orange Juice that had been aseptically cold-filled. The other was a from-concentrate juice branded as MINUTE MAID Orange Juice, which had been hot filled. The TROPICANA and MINUTE MAID juice products were 2 to 3 months old.

The experiment was a sequential monadic test of overall liking followed by a three-sample ranking preference test of 105 random (non-screened) visitors to the Florida's Natural Growers Grove House in Lake Wales, Fla. from Jun. 6-9 and 13, 2005. Overall liking was measured by using a 9-point scale ranging from 1 for “dislike extremely” to 9 for “like extremely”. The scale was centered at 5 for “neither like nor dislike”. For the ranking preference test, the panelist was asked to taste and rank the samples in order of overall preference, with 1 being most preferred and 3 being least preferred. Samples were presented in 3-digit coded cups. Order of presentation of the samples was randomized. Differences in mean overall liking scores were analyzed using Analysis of Variance followed by means separation using the t-Test from the MICROSOFT EXCEL Analysis ToolPak. Differences in preference rank sums were analyzed using the Friedman test followed by rank sum separation using the least significant difference procedure.

The below Table I is a comparison of attributes of the juice products tested. Included in the analysis are: Brix, which is a measure of the total soluble solids in the juice; OJ Index, which is a US Department of Agriculture designation for different grades of pasteurized orange juice depending upon the color of the juice; percent of total acid in the juice; Scott oil percent, which reveals the amount of d-limonene present in the juice; ratio or ⁰Brix/Acid Ratio, which is determined by simple division of the Brix and the total acid present; pH; percent bottom pulp and percent vitamin C.

TABLE I
JUICE ANALYSIS

| | Florida's Natural | | |
|---|---|---|---|
| | (produced by the | | |
| | present | | |
| | invention) | Tropicana | Minute Maid |
| Brix, corrected | 11.9 | 11.8 | 11.9 |
| Acid, % | 0.69 | 0.71 | 0.71 |
| Ratio | 17.2 | 16.6 | 16.8 |
| PH | 3.71 | 3.71 | 3.62 |
| Scott Oil, % | 0.022 | 0.027 | 0.006 |
| OJ Index | 35.6 | 36.8 | 36.4 |
| Bottom Pulp, % | 15 | 14 | 6 |
| Vitamin C, | 212 | 170 | 258 |
| % DV/240 mL | | | |

The comparison of the attributes of the juices revealed that all three juices had similar analytical properties, with the exception of the MINUTE MAID product having lower oil and lower bottom pulp.

The results of the overall liking and preference of the juice is represented in Table II below. The results are based on a nine point scale ranging from 1 for dislike extremely to 9 for like extremely.

TABLE II

| Juice brand | Mean Overall Liking | 1^{st} Position Overall Liking |
|---|---|---|
| Florida's Natural | 7.2 | 7.5 |
| (produced by the | | |
| present invention) | | |
| Tropicana | 7.1 | 7.3 |
| Minute Maid | 6.2 | 6.4 |

The results of the preference test for mean overall liking indicate that the three juices did not taste similar. There were no significant differences between the overall liking score of the juice product of the present invention and TROPICANA; however, both of the scores of the overall liking of the juice product of the invention and TROPICANA were significantly higher than MINUTE MAID. The TROPICANA juice is considered a higher quality or premium not-from-concentrate orange juice. Accordingly, the results of the test show that the new hot fill process of the invention produces a product that has equal acceptability with consumers as a premium, cold-filled juice. However, the juice produced by the invention has a significantly longer shelf life than the other premium product tested. The rapid cooling processes of the invention and the refrigerated storage help to differentiate the product and keep it in the category of high quality not-from-concentrate juice. As shown in Table I, there were no appreciable differences in Brix, acidity, or color among the juices, so it is assumed that flavor was the main factor in the taste test.

The hot fill and quick chill processes of the invention can be used to protect qualities of various other products, including, but not limited to juice drinks, juice cocktails, juice concentrates, juice smoothies, teas, nectars, sport drinks, nutritional drinks, vegetable drinks and energy drinks.

Accordingly, it will be understood that the preferred embodiment of the present invention has been disclosed by way of example and that other modifications and alterations may occur to those skilled in the art.

What is claimed is:

1. A process for hot filling a beverage into containers comprising the steps of:
(a) pasteurization of a pre-chilled beverage stored in a batch tank;
(b) rapidly cooling any diverted beverage and any overflow beverage and returning it to a batch tank;
(c) filling a container with the hot beverage and sealing said container;
(d) rapidly cooling said filled beverage container with a chilled water spray; and
(e) maintaining refrigeration of said filled beverage container throughout shipment and storage.

2. The process of claim 1, wherein pasteurization of said pre-chilled beverage comprises heating the pre-chilled beverage to a temperature in the range of 195° F. to 215° F.;

3. The process of claim 1, wherein said batch tank contains said pre-chilled beverage at a temperature in the range of 33° F. to 50° F.

4. The process of claim 1, wherein said chilled water spray is at a temperature of 35 ° F., whereby the beverage temperature of said filled beverage container is reduced to a temperature in the range of 33° F. to 50° F. in 7 to 30 minutes.

5. The process of claim 1, wherein said filled beverage container is maintained at a temperature in the range of 35° F. to 40° F. during shipment and throughout storage.

6. The process of claim 1 wherein said diverted beverage and said overflow beverage are cooled with a chilled glycol/water mixture.

7. The process of claim 1 wherein said chilled water spray of step (d) is cooled by cycling the water through a refrigerant.

8. The process of claim 1 wherein said beverage is a premium not-from-concentrate juice.

9. A process for hot filling not-from-concentrate juice in a container comprising:
(a) pasteurization of a chilled not-from-concentrate juice;
(b) filling a container with the hot not-from-concentrate juice and sealing the container;
(c) rapidly cooling the filled not-from-concentrate juice container with a chilled water spray; and
(d) maintaining refrigeration of said filled not-from-concentrate juice container throughout shipment and storage.

10. The process of claim 9, wherein said pasteurization comprises heating said chilled not-from-concentrate juice from a temperature in the range of 33° F. to 50° F. to a temperature in the range of 195° F. to 215° F.

11. The process of claim 9, whereby said chilled water spray rapidly cools the filled not-from-concentrate juice container to a temperature in the range of 33° F. to 50° F. in 7 to 30 minutes.

12. The process of claim 9 wherein the filled not-from-concentrate juice container is maintained at a temperature in the range of 35° F. to 40° F. throughout shipment and storage.

13. The process of claim 9, further comprising rapidly cooling any diverted not-from-concentrate juice and any overflow not-from concentrate juice in a heat exchanger prior to returning it to a batch tank.

14. The process of claim 9 wherein the chilled water spray is at a temperature in the range of 33° F. to 45° F.

15. The process of claim 9 further comprising agitating the filled not-from-concentrate juice container during the rapid cooling step.

16. The process of claim 9 wherein the rapid cooling step reduces the temperature of the filled not-from-concentrate juice container to a temperature in the range of 40° F. to 50° F. in 12 to 23 minutes, depending upon the size of the container.

17. A process for hot filling not-from-concentrate juice in a container comprising:
(a) cooling said not-from concentrate juice in a batch tank;
(b) pasteurizing said chilled not-from-concentrate juice;
(c) returning a portion of said not-from-concentrate juice to said batch tank through a diversion flow after pasteurization;
(d) rapidly cooling said diverted not-from-concentrate juice through use of a heat exchanger prior to returning said not-from-concentrate juice to said batch tank;
(e) returning a portion of said not-from-concentrate juice which is overflow from a filling station to said batch tank;
(f) rapidly cooling said overflow not-from-concentrate juice through use of a heat exchanger prior to returning said not-from-concentrate juice to said batch tank;
(g) filling said container with said not-from-concentrate juice and sealing said container;
(h) rapidly cooling the filled not-from-concentrate juice container with a chilled water spray; and
(i) maintaining refrigeration of the filled not-from-concentrate juice container throughout shipment and storage.

18. The process of claim 17, wherein said not-from concentrate juice in said batch tank is at a temperature in the range of 33° F. to 50° F.

19. The process of claim 17, wherein said pasteurization comprises heating said not-from-concentrate juice to a temperature in the range of 195° F. to 215° F.

20. The process of claim 17, wherein said overflow and said diverted not-from-concentrate juice is rapidly cooled to a temperature in the range of 33° F. to 50° F.

21. The process of claim 17, wherein the chilled water spray is at a temperature in the range of 33° F. to 45° F. and whereby the filled not-from-concentrate juice temperature is reduced to a temperature in the range of 33° F. to 50° F. in 7 to 30 minutes.

22. The process of claim 17, wherein the filled not-from- concentrate juice container is maintained at a temperature in the range of 35° F. to 40° F. throughout shipment and storage.

23. The process of claim 17 further comprising agitating the filled not-from-concentrate juice container during the cooling step (f).

24. The process of claim 17 wherein said chilled water spray of step (f) is circulated through a refrigeration system that maintains the temperature of said chilled water spray.

25. The process of claim 17 wherein the cooling step reduces the temperature of the filled not-from-concentrate juice to a temperature in the range of 40° F. to 50° F. in 12 to 23 minutes depending upon the size of the container.

26. A not-from-concentrate juice made by a process comprising:
(a) cooling said not-from concentrate juice in a batch tank;
(b) pasteurizing said chilled not-from-concentrate juice;
(c) returning a portion of said not-from-concentrate juice to said batch tank through a diversion flow after pasteurization;
(d) rapidly cooling said diverted not-from-concentrate juice through use of a heat exchanger prior to returning said not-from-concentrate juice to said batch tank;
(e) returning a portion of said not-from-concentrate juice which is overflow from a filling station to said batch tank;
(f) rapidly cooling said overflow not-from-concentrate juice which through use of a heat exchanger prior to returning said not-from-concentrate juice to said batch tank;
(g) filling a container with said not-from-concentrate juice and sealing said container;
(h) rapidly cooling the filled not-from-concentrate juice container with a chilled water spray; and
(i) maintaining refrigeration of the filled not-from-concentrate juice container throughout shipment and storage.

27. The process of claim 26, wherein said not-from concentrate juice in said batch tank is at a temperature in the range of 33° F. to 50° F.

28. The process of claim 26, wherein said pasteurization comprises heating said not-from-concentrate juice to a temperature in the range of 195° F. to 215° F.

29. The process of claim 26, wherein said overflow and said diverted not-from-concentrate juice is rapidly cooled to a temperature in the range of 33° F. to 50° F.

30. The process of claim 26, wherein the chilled water spray is at a temperature in the range of 33° F. to 45° F. and whereby the filled not-from-concentrate juice temperature is reduced to a temperature in the range of 33° F. to 50° F. in 7 to 30 minutes.

31. The process of claim 26, wherein the filled not-from-concentrate juice container is maintained at a temperature in the range of 35° F. to 40° F. throughout shipment and storage.

32. The process of claim 26 further comprising agitating the filled not-from-concentrate juice container during the cooling step (f).

33. The process of claim 26 wherein said chilled water spray of step (f) is circulated through a refrigeration system that maintains the temperature of said chilled water spray.

34. The process of claim 26 wherein the cooling step reduces the temperature of the filled not-from-concentrate juice to a temperature in the range of 40° F. to 50° F. in 12 to 23 minutes depending upon the size of the container.

35. A process for hot filling a beverage into containers comprising the steps of:
(a) pasteurization of a pre-chilled beverage stored in a batch tank, wherein pasteurization of said pre-chilled beverage comprises heating the pre-chilled beverage from a temperature in the range of 33° F. to 50° F. to a temperature in the range of 195° F. to 215° F.;
(b) rapidly cooling any diverted beverage and any overflow beverage with a chilled glycol/water mixture and returning it to a batch tank;
(c) filling a container with the hot beverage and sealing said container;
(d) rapidly cooling said filled beverage container with a chilled water spray at a temperature of 35° F., wherein said chilled water spray temperature is maintained by cycling the water through a refrigerant, and whereby the beverage temperature of said filled beverage container is reduced to a temperature in the range of 33° F. to 50° F. in 7 to 30 minutes; and
(e) maintaining refrigeration of said filled beverage container at a temperature in the range of 35° F. to 40° F. throughout shipment and storage.

36. A process for hot filling not-from-concentrate juice in a container comprising:
(a) pasteurization of a chilled not-from-concentrate juice, wherein said pasteurization comprises heating said chilled not-from-concentrate juice from a temperature in the range of 33° F. to 50° F. to a temperature in the range of 195° F. to 215° F.;
(b) rapidly cooling a diverted not-from-concentrate juice and an overflow not-from concentrate juice in a. heat exchanger prior to returning it to a batch tank;
(c) filling a container with the hot not-from-concentrate juice and sealing the container;
(d) rapidly cooling the filled not-from-concentrate juice container with a chilled water spray, wherein the chilled water spray is at a temperature in the range of 33° F. to 45° F., and whereby said chilled water spray rapidly cools the filled not-from-concentrate juice container to a temperature in the range of 33° F. to 50° F. in 7 to 30 minutes; and
(e) maintaining refrigeration of said filled not-from-concentrate juice container throughout shipment and storage, wherein the filled not-from-concentrate juice container is maintained at a temperature in the range of 35° F. to 40° F. throughout shipment and storage.

37. A process for hot filling not-from-concentrate juice in a container comprising:
(a) cooling not-from concentrate juice in a batch tank to a temperature in the range of 33° F. to 50° F.;
(b) pasteurizing said chilled not-from-concentrate juice, wherein said pasteurization comprises heating said chilled not-from-concentrate juice to a temperature in the range of 195° F. to 215° F.;
(c) returning a portion of said not-from-concentrate juice to said batch tank through a diversion flow after pasteurization;
(d) rapidly cooling said diverted not-from-concentrate juice to a temperature in the range of 33° F. to 50° F. through use of a heat exchanger prior to returning said not-from-concentrate juice to said batch tank;
(e) returning a portion of said not-from-concentrate juice which is overflow from a filling station to said batch tank;
(f) rapidly cooling said overflow not-from-concentrate juice to a temperature in the range of 33° F. to 50° F. through use of a heat exchanger prior to returning said not-from-concentrate juice to said batch tank;
(g) filling said container with said not-from-concentrate juice and sealing said container;
(h) rapidly cooling the filled not-from-concentrate juice container with a chilled water spray, wherein the chilled water spray is maintained at a temperature in the range of 33° F. to 45° F. by circulation through a refrigeration system and whereby the filled not-from-concentrate juice temperature is reduced to a temperature in the range of 33° F. to 50° F. in 7 to 30 minutes; and
(i) maintaining refrigeration of the filled not-from-concentrate juice container at a temperature in the range of 35° F. to 40° F. throughout shipment and storage.
